(19) United States
(12) Patent Application Publication
(10) Pub. No.: US 2025/0293290 A1
(43) Pub. Date: Sep. 18, 2025

(54) HONEYCOMB BORON CARBON NITRIDE (HBCN) AS ANODE FOR SODIUM-ION BATTERY

(71) Applicant: COUNCIL OF SCIENTIFIC AND INDUSTRIAL RESEARCH, New Delhi (IN)

(72) Inventors: Manjusha Vilas SHELKE, Pune (IN); Poonam YADAV, Pune (IN); Indrapal KARBHAL, Pune (IN)

(73) Assignee: COUNCIL OF SCIENTIFIC AND INDUSTRIAL RESEARCH, New Delhi (IN)

(21) Appl. No.: 18/856,539

(22) PCT Filed: Apr. 11, 2023
(86) PCT No.: PCT/IN2023/050354

§ 371 Date: Oct. 11, 2024

(30) Foreign Application Priority Data
Apr. 12, 2022 (IN) 202211022002

(51) Int. Cl. H01M 10/054; H01M 4/02; H01M 4/58; H01M 4/62; H01M 10/0568; H01M 10/0569; H01M 50/417; H01M 50/437

(52) U.S. Cl. CPC H01M 10/054; H01M 4/5825; H01M 4/622; H01M 4/625; H01M 10/0568; H01M 10/0569; H01M 50/417; H01M 50/437; H01M 2004/021

(57) ABSTRACT

The present invention relates to Na-ion batteries comprising honey comb boron carbon nitride (HBCN) as an anode. More particularly, the present invention relates to half-cell and full cell Na-ion batteries comprising honey comb boron carbon nitride (HBCN) nanomaterial as an anode.

### TECHNICAL FIELD OF THE INVENTION

Generally, the present invention relates to sodium ion-based batteries or electrochemical devices. Particularly, the present invention relates to a sodium-ion battery or electrochemical device comprising Honeycomb Boron carbon nitride (HBCN) as an anode. More particularly, the present invention relates to a half-cell and full-cell sodium-ion battery or electrochemical device comprising Honeycomb Boron carbon nitride (HBCN) nanomaterial as an anode.

### BACKGROUND AND PRIOR ART OF THE INVENTION

Na-ion battery (NIB) is low-cost alternative to existing Li-ion batteries. But several challenges remain unsolved such as less stability, high reactivity and low energy density. To achieve high energy density, significant efforts have been employed for the development of alternate carbon-based anode chemistries, due to their robust architectural stability and superior electrochemical behaviour. Properties, such as unique structural morphology, large pore volume, excellent mechanical and thermal stability, inexpensive with easier availability, etc. makes these carbon materials an obvious choice of designing electrode for NIBs. 3D porous carbon-based materials are well known for their excellent mechanical and electrochemical properties for various energy storage applications, e.g., as reported in article Wenyang Zhou et al., Carbon Volume 168, 30 Oct. 2020, Pages 163-168. However, their commercial application is limited due to their low theoretical specific capacity. Further, said article reports theoretical based results without support of any experimental method and characterization, which limits their use.

Heteroatom doping in carbonaceous networks proved an efficient way to modify the surface properties, which considerably improves the Na intake capacity and Na diffusion in porous carbon materials. Systematic doping of heteroatom like Boron (B), Nitrogen (N), Phosphorous (P), Sulphur(S), and Fluorine (F) in the carbon matrix can potentially tune the surface, electronic and diffusion properties of carbon materials to enhance the theoretical limits on specific capacity. Some of articles report such type of doping of carbon matrix with heteroatom, e.g., a) Preeti Bhauriyal et al., J. Phys. Chem. C 2018, 122, 5, 2481-2489; and b) Nabil Khossossi et al., Nano Energy Volume 96, 1 Jun. 2022, 107066. However, none of these articles reports effective doping of combination of heteroatoms to obtain efficient Na-ion battery.

Further, N doping in the carbonaceous framework has been most comprehensively studied and resulted in a significant enhancement in the electrochemical behaviour of graphitic and porous carbon. N atoms generally bond with carbon atoms with three common bonding configurations named pyridinic N, pyrrolic N, and graphitic N in carbon matrix replacing carbon. Similarly, Boron is an equally important dopant that is known to induce the complementary electronic properties to those of Nitrogen leading to specific application purposes.

Thus, there is still a need to arrive at the effective sodium ion battery having better or improved capacity, activity and shelf life.

Therefore, the inventors of the present application developed a battery having combined doping of N and B which helped in achieving high doping efficiency in a synergistic manner. Combined effects of heteroatom doping with porous carbon architecture provided excellent charge transfer, ion diffusion properties of the doped surface and higher defect density in an anode material for NIB.

### Objectives of the Invention

Accordingly, it is an objective of the present invention to provide sodium-ion batteries comprising porous honeycomb boron carbon nitride (HBCN) material as an anode.

### SUMMARY OF THE INVENTION

In an aspect, the present invention provides half-cell and full cell sodium ion batteries comprising 3D honeycomb boron carbon nitride (HBCN) as an anode.

In another aspect, the present invention relates to a sodium ion battery, comprising:
a) mesoporous honeycomb boron carbon nitride nanomaterial plated/deposited with sodium as anode,
b) Na₃V₂(PO₄)₂F₃ (NVPF) as cathode,
c) electrolyte(s),
d) optionally, additive, and
e) separator.

In another aspect, the honeycomb boron carbon nitride (HBCN) disclosed herein has a porosity in the range from 300 to 500 nm and mesoporosity in a range of 2 to 10 nm.

In another aspect, the honeycomb boron carbon nitride (HBCN) has a surface area ranging between 400-800 m².

In another aspect, the electrolyte(s) is selected from a group comprising of sodium hexafluorophosphate salt in diglyme (NaPF₆-diglyme), sodium hexafluorophosphate salt in ethylene carbonate/propylene carbonate+fluoroethylene carbonate (NaPF₆-EC/PC+FEC), sodium hexafluorophosphate salt in propylene carbonate (NaPF₆-PC), sodium hexafluorophosphate salt in ethylene carbonate/diethyl carbonate+fluoroethylene carbonate (NaPF₆-EC/DEC+FEC), sodium perchlorate-ethylene carbonate/dimethyl carbonate+fluoroethylene carbonate (NaClO₄-EC/DMC+FEC), or mixture thereof.

In another aspect, the separator is selected from Whatman glass fiber or celgard.

In another essential aspect, the sodium ion battery is in the form of half-cell or full cell battery.

In another aspect, the mass loading of anode to cathode in said battery is in a range from 1:1 to 1:3.

In another aspect, the cathode and anode are pre-sodiated by shorting for 10-90 minutes.

In another aspect, the capacity of the anode in half cell battery is in a range of 140 to 290 mAhg⁻¹ in different electrolyte systems, obtained at 100 mAg⁻¹ current density.

In another aspect, the capacity for the cathode in half cell battery is in a range of 100-110 mAhg⁻¹, obtained at 100 mAg⁻¹ of current density.

In another aspect, the capacity of the pre-sodiated cathode in full cell battery is 33 mAhg⁻¹ at 50 mAg⁻¹ of current density.

In another aspect, the capacity of the pre-sodiated anode in full cell battery is 28 mAhg⁻¹ at 50 mAg⁻¹ of current density.

In another aspect, the capacity of presodiated cathode and anode in full cell battery is 41 mAhg⁻¹ at 50 mAg⁻¹ of current density.

In another aspect, the present invention relates to a process for preparation of the anode, comprising:
i. mixing a mesoporous honeycomb boron carbon nitride (HBCN) nanomaterial as active material, a conducting additive and a binder in a ratio of 70:10:10 or 80:10:10, in a solvent.
ii. Casting slurry on current collector, i.e., conducting metal and drying at 70-120° C. for 12-24 hours in vacuum oven.

In another aspect, the conducting additive is selected from super P carbon black, C65 and CNT.

In another aspect, the binder is selected from polyvinylidene fluoride, carboxymethylcellulose, and polyacrylic acid.

In another aspect, the solvent is N-Methyl-2-pyrrolidone or water.

The 3D honeycomb boron carbon nitride (HBCN) is synthesised by employing boric acid, glucose and cyanamide. Silica nanoparticles (SiO₂ NPs) are used as structure-directing agents to replicate well-organized honeycomb structures.

In another aspect, the invention provides the preparation of HBCN electrode. Accordingly, the HBCN electrodes were prepared by mixing active material (HBCN), conducting additive (super P carbon black) and PVDF binder in a ratio of 70:10:10, respectively using NMP solvent. The cathode material NVPF (Na₃V₂(PO₄)₂F₃) electrodes were prepared by mixing active material (NVPF), conducting additive (super P) and PVDF binder in a ratio of 80:10:10 respectively. The prepared slurry was coated on copper and C-coated aluminium foil used as current collector and subsequently dried at 80° C. in oven for overnight. Circular electrodes were cut down using electrode cutter in 14 mm diameter.

In another aspect, the invention provides preparation of electrodes for use in full cell, wherein, the mass loading of anode to cathode used is 1:2. Cathode and anodes were pre-sodiated by shorting for 30 minutes.

In yet another aspect, the invention provides CR2032 cell fabrication, wherein, the cells were fabricated in Ar filled glove box (oxygen level<0.1 ppm and H₂O level<0.1 ppm) in CR2032 cell assembly with Na as counter and reference electrode. The electrolytes used in CR2032 cell fabrication is selected from a) 1 M NaClO₄ in 1:1 EC and DMC with 5% FEC; b) 1 M NaPF₆ in 1:1 EC and DEC with 5% FEC; c) 1 M NaPF₆ in PC with 5% FEC; and d) 1 M NaPF₆ in diglyme.

Whatman glass fiber was used as separator to separate negative and positive electrodes.

### BRIEF DESCRIPTION OF DRAWINGS

FIG. 1: Components of Na ion battery.

FIG. 2: Rate performance of HBCN in (a) 1M NaPF₆-glyme (b) 1 M NaClO₄ in 1:1 EC and DMC with 5% FEC.

FIG. 3: Stability comparison of HBCN in 1M NaPF₆-glyme, 1 M NaPF₆ in 1:1 EC:DEC with 5% FEC, and 1 M NaClO₄ in 1:1 EC:DMC with 5% FEC.

FIG. 4: Stability of NVPF half-cell.

FIG. 5: HBCN∥NVPF CV (a) full cell without pre-sodiation (b) cathode and anode pre-sodiated for 30M.

FIG. 6: HBCN∥NVPF full cell stability data using different presodiation conditions in 1 M NaPF₆ in 1:1 EC:DEC with 5% FEC and b zoomed figure.

FIG. 7: HBCN∥NVPF GCD in 1 M NaPF₆ in 1:1 EC:DEC with 5% FEC (a) without pre-sodiation (b) Cathode presodiation.

FIG. 8: HBCN∥NVPF GCD (a) anode presodiation (b) Anode and cathode both presodiated.

### DETAILED DESCRIPTION OF THE INVENTION

The invention will be described in detail in connection with certain preferred and optional embodiments, so that various aspects thereof may be fully understood and appreciated.

The term “additive” or “conducting additive” used herein means same and can be used interchangeably.

The terms “honeycomb boron carbon nitride” or “HBCN” or “porous or mesoporous HBCN” or “3D rigid honeycomb boron carbon nitride (HBCN)” are used herein interchangeably with the same meaning as a material having honeycomb like shape/arrangements of atoms where nitrogen and boron heteroatoms are doped in the carbon matrix structure.

The term “pre-sodiation” used herein involves depositing sodium on anode. Sodium metal is kept in direct contact with anode electrode and electrically shorted using metal clips.

The term “shorting” used herein means an electrical short, is a low-resistance connection between two conductors (objects that allow electricity to flow through them). Accordingly, the present invention provides half-cell and full cell sodium ion batteries comprising 3D honeycomb boron carbon nitride (HBCN) as an anode.

The 3D rigid mesoporous honeycomb boron carbon nitride (HBCN) nanomaterial with porosity in the range of 300 to 500 nm and mesoporosity in the range of 2 to 10 nm is used as an anode material for sodium ion battery.

In an embodiment, the present invention provides an anode for the sodium ion battery which comprises a 3D honeycomb boron carbon nitride with porosity in the range from 300 to 500 nm and in mesoporosity in the range of 2 to 10 nm.

In an embodiment, the 3D rigid mesoporous nanomaterial of boron carbon nitride (HBCN) has a surface area in the range of 400-800 m²g⁻¹.

In another embodiment, the invention provides the preparation of HBCN electrode. Accordingly, the HBCN electrodes were prepared by mixing HBCN as active material, conducting additive (super P carbon black) and polyvinylidene fluoride (PVDF) binder in a ratio of 70:10:10, respectively using N-Methyl-2-pyrrolidone (NMP) solvent.

The cathode NVPF (Na₃V₂(PO₄)₂F₃) electrodes were prepared by mixing NVPF, conducting additive (super P carbon black) and PVDF binder in a ratio of 80:10:10 respectively. The prepared slurry was coated on copper and C-coated aluminium foil used as current collector and subsequently dried at 80° C. in oven for overnight. Circular electrodes were cut down using electrode cutter in 14 mm diameter.

In another aspect, the invention provides preparation of electrodes for use in full-cell, wherein, the mass loading of anode to cathode used is 1:2. Cathode and anode were pre-sodiated by shorting for 30 minutes.

In yet another aspect, the invention provides CR2032 cell fabrication, wherein, the cells were fabricated in Ar filled glove box (oxygen level<0.1 ppm and H₂O level<0.1 ppm) in CR2032 cell assembly with Na as counter and reference electrode. The electrolytes used are in CR2032 cell fabrication is selected from a) 1 M NaClO₄ in 1:1 EC and DMC with 5% FEC; b) 1 M NaPF₆ in 1:1 EC and DEC with 5% FEC; c) 1 M NaPF₆ in PC with 5% FEC; and d) 1 M NaPF₆ in diglyme. Whatman glass fiber was used as separator to separate negative and positive electrodes.

In yet another embodiment, electrochemical measurements were performed using MTI corporation battery analyser with constant current charge-discharge in half-cell and full cell. 1C is 128 mAhg⁻¹ for full cell studies. CV and EIS measurements were performed using biologic VMP 3.0.

### HBCN as Anode in Half-Cell:

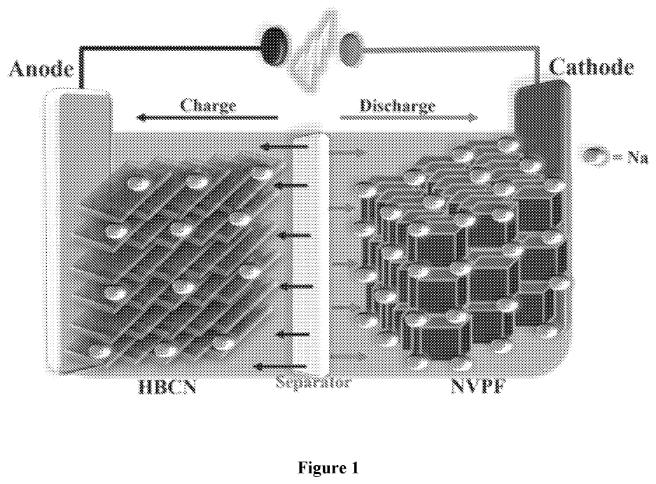

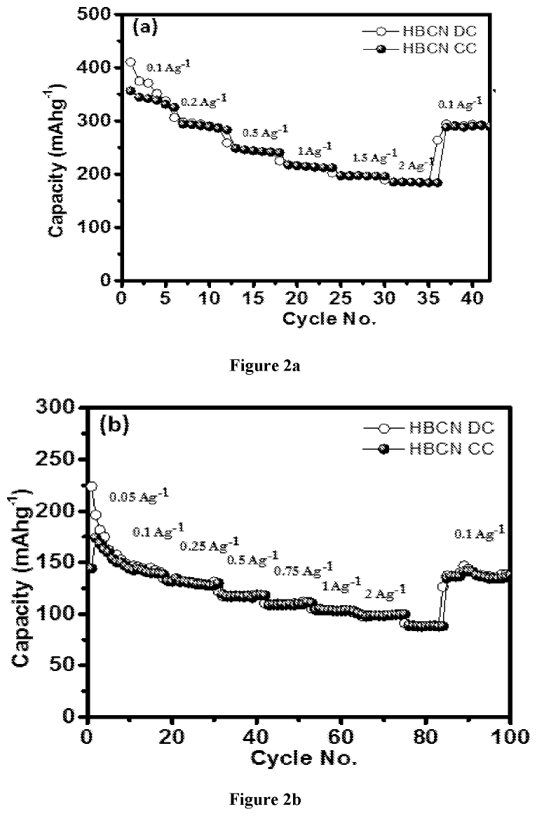

Considering the dual doping and tailored structure of HBCN, HBCN was tested as anode for Na-ion battery. HBCN was tested as anode in half-cell in different electrolytes. Assembly of cell is represented in FIG. 1. Rate performance of HBCN is shown in FIG. 2. Capacity obtained at 100 mAg⁻¹ in NaPF₆-diglyme based electrolyte is 290 mAhg⁻¹ and in NaClO₄-EC/DMC electrolyte, the capacity obtained is 140 mAhg⁻¹. Capacity comparison of HBCN with the published carbon-based anodes has been provided in table 1. HBCN shows highest capacity at higher current density of 100 mAhg⁻¹. Capacity of P-doped carbon may appear higher, but it is at lower current density of 20 mAhg⁻¹.

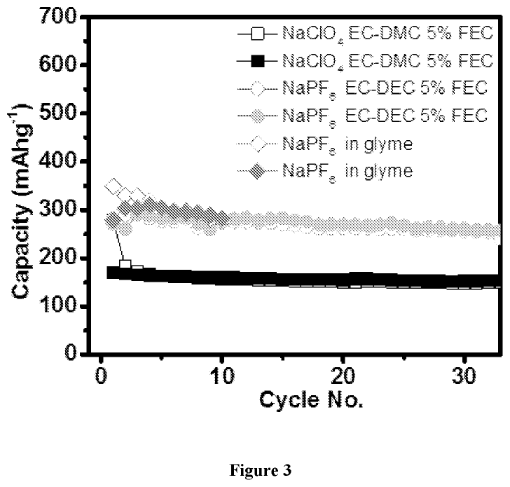

Stability comparison of HBCN in different electrolytes is shown in FIG. 3 which indicates that half-cell capacity is similar in 1M NaPF₆-glyme and 1 M NaPF₆ in 1:1 EC and DEC with 5% FEC electrolytes. But capacity is lower in 1 M NaClO₄ in 1:1 EC and DMC with 5% FEC Electrolyte.

TABLE 1
Capacity comparison of anode materials for Na-ion battery

| | | Capacity/Current | |
|---|---|---|---|
| | | density/cycle | |
| S. No. | Material | number | Journal/Reference |
| 1 | Hard Carbon | 282 mAhg⁻¹/30 | Electrochimica Acta |
| | | mAg⁻¹/50 | 353 (2020) 136566 |
| 2 | Hard Carbon | 146 mAhg⁻¹/200 | Carbon 143 (2019) |
| | | mAg⁻¹/— | 402-412 |
| 3 | Hard Carbon | 300 mAhg⁻¹/50 | J. Mater. Chem. A, |
| | | mAg⁻¹/200 | 2015, 3, 20560-20566 |
| 4 | P-doped Hard | 386 mAhg⁻¹/20 | Adv. Energy Mater. |
| | Carbon | mAg⁻¹/100 | 2018, 8, 1702781 |
| 5 | C-coated Hard | 272 mAhg⁻¹/25 | Energy Technol. |
| | Carbon | mAg⁻¹/50 | 2019, 7, 1900779 |
| 6 | Al₂O₃ coated Hard | 300 mAhg⁻¹/50 | Nano Energy 2019, |
| | Carbon | mAg⁻¹/150 | 64, 103903 |
| 7 | Hard Carbon + | 215 mAhg⁻¹/50 | Adv. Energy Mater. |
| | Soft Carbon | mAg⁻¹/120 | 2018, 8, 1801441 |
| 8 | HBCN | 290 mAhg⁻¹/100 | Present Invention |
| | | mAg⁻¹/100 | |

### NVPF as a Cathode in Half-Cell:

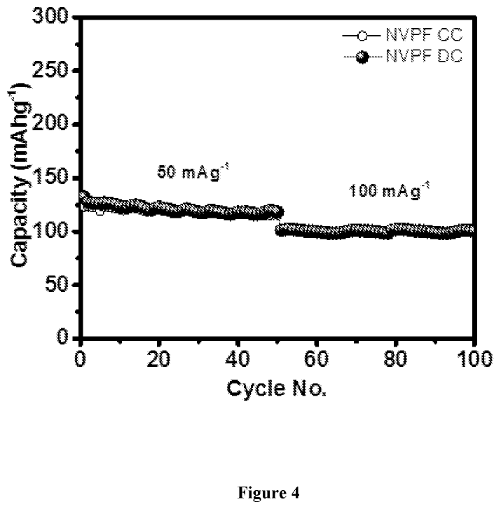

Half-cell performance of NVPF as a cathode is shown in FIG. 4 in diglyme electrolyte. Capacity obtained for NVPF at 100 mAhg⁻¹ is 110 mAhg⁻¹.

### HBCN∥NVPF Full Cell:

Based on the half-cell performance of HBCN and NVPF, mass balancing was done and for full cell, the mass ratio of cathode to anode is considered as 2:1. Before fabricating full cell, anode and cathode electrodes were pre-sodiated for 30 minutes.

Four different pre-sodiation conditions studied before fabricating full cell, which are:
a) Without pre-sodiation;
b) Cathode pre-sodiated for 30M;
c) Anode pre-sodiated for 30M; and
d) Anode and cathode pre-sodiated for 30M.

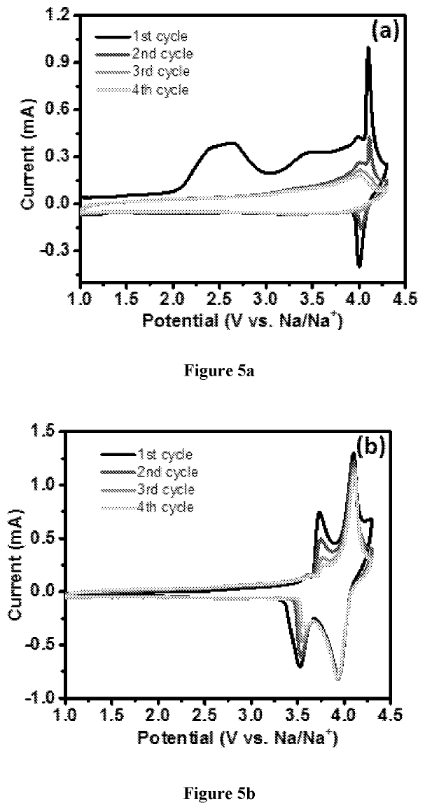

The cyclic voltammetry (CV) curves of cathode and anode without pre-sodiated and pre-sodiated are shown in FIG. 5. From the CV curves it can be observed that the reversibility of peak at 4.1 V is increased in the case of pre-sodiated electrodes than full cell without pre-sodiated electrodes.

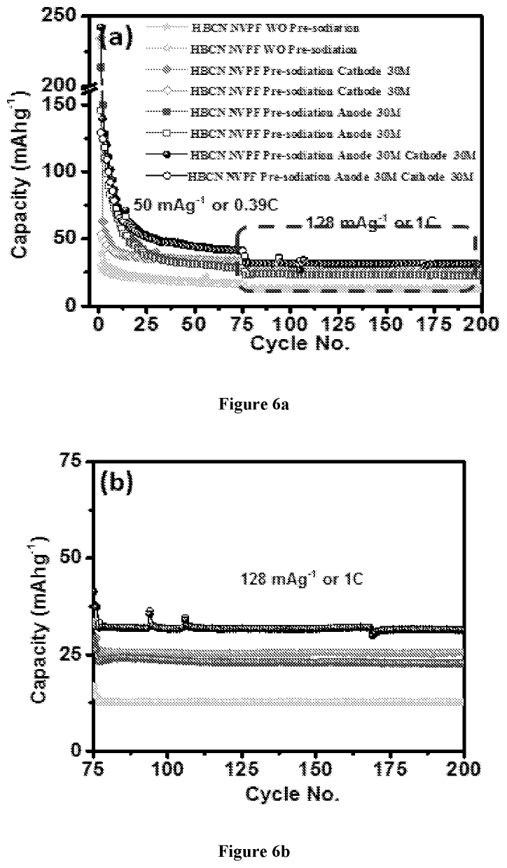

Furthermore, the increase in the capacity retention in the case of pre-sodiated full cell can be understood from stability data obtained. Full cell stability data is shown in FIG. 6. In the case of full cell fabricated without pre-sodiation of electrodes, the capacity is 16 mAhg⁻¹ at 50 mAg⁻¹ (0.39C). In cathode pre-sodiated full cell, the capacity is 33 mAhg⁻¹ at 50 mAg⁻¹. In anode pre-sodiated full cell, the capacity is 28 mAhg⁻¹ at 50 mAg⁻¹. In full cell wherein cathode and anode both pre-sodiated, capacity is 41 mAhg⁻¹ at 50 mAg⁻¹.

At 128 mAhg⁻¹ (1C), the capacities obtained are 12, 25, 22 and 31 mAhg⁻¹ in case of without pre-sodiation, cathode pre-sodition, anode pre-sodiation and both electrodes pre-sodiation case.

Capacity of HBCN∥NVPF full cell is shown in table 2 below.

TABLE 2
Capacity of HBCN ∥ NVPF full cell

| | Without | | | |
|---|---|---|---|---|
| | pre- | | | Cathode 30 M |
| Current | sodiation | Cathode 30 M | Anode 30 M | Anode 30 M |
| Density | (mAhg⁻¹) | (mAhg⁻¹) | (mAhg⁻¹) | (mAhg⁻¹) |
| 50 mAg⁻¹ | 16 | 33 | 28 | 41 |
| (0.39 C) | | | | |
| 128 mAhg⁻¹ | 12 | 25 | 22 | 31 |
| (1 C) | | | | |

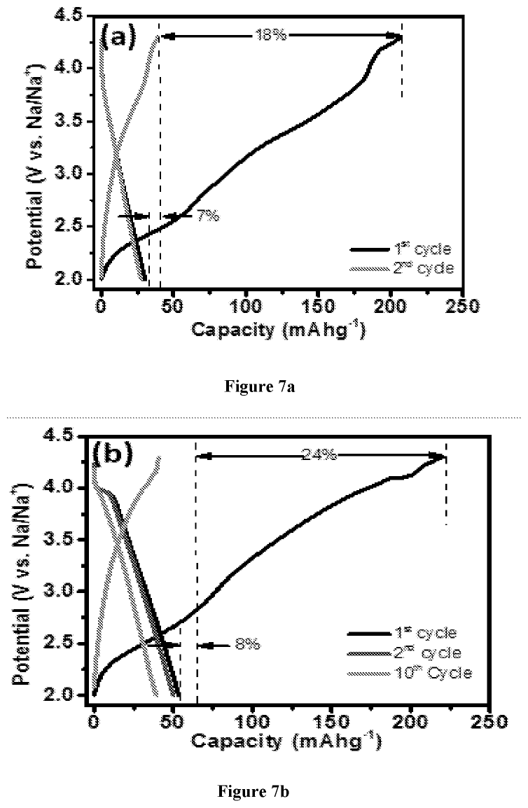

Galvanostatic charge-discharge (GCD) curves of different full cells are shown in FIG. 7. In full cell without pre-sodiation, due to irreversible loss of Na-ion during solid electrolyte interphase (SEI) formation, the capacity retention in 2nd charge cycle is 18%. When cathode was pre-sodiated for 30M, Cathode electrolyte interphase (CEI) will be formed before full cell fabrication so irreversible loss of Na ions will be decreased and capacity retention was increased to 24%. In anode pre-sodiation, capacity retention was increased to 68% due to SEI formation on anode so no irreversible trapping of Na-ions was observed. When anode and cathode both were pre-sodiated, capacity retention is 55% and stable capacity is highest among all cases.

### EXAMPLES

### Example 1: Preparation of HBCN

The synthetic process and characterization of synthesized HBCN is well explained in inventor's own post-priority published article and applicant's co-pending Indian patent application, which are referred in this application in its entirety. The bibliographic details are: “Manjusha V. Shelke et al., “Honeycomb Boron Carbon Nitride as High-Performance Anode Material for Li-Ion Batteries” CHEMNANOMAT, 2022, Volume 8, Issue 7, e202200056. https://doi.org/10.1002/cnma.202200056, Published: 25 May 2022.”; and co-pending Indian Patent Application number 202111002835. Some of synthesis and characterization details are provided below:

Materials: Glucose, Cyanamide and tetraethyl orthosilicate (TEOS), boric acid and isopropyl alcohol (IPA), ammonia solution were procured for synthesis of HBCN. Conducting carbon (carbon black-99.99%), polyvinylidene fluoride (PVDF) and N-methyl-2-pyrrolidone used for the preparation of electrodes.bis(trifluoromethane) sulfonimide lithium salt (LITFSI), dioxolane (DOL), dimethoxyethane (DME), lithium nitrate (LiNO₃), lithium hexafluorophosphate (LiPF₆), ethylene carbonate (EC), dimethyl carbonate (DMC), fluoroethylene carbonate (FEC), NaPF₆ and Diglyme were used for the preparation of electrolyte. Lithium discs, sodium metal and Celgard separator were used in battery fabrication. All materials were used as received. Silica NPs were synthesized by well-known Stober method with NPs of size in range from 300 to 500 nm and used as templates for HBCN synthesis. In general silica NPs of size ranges from 50 to 500 nm can also be synthesized using Stober method. Moreover, commercial silica NPs of required size range can also be procured for further synthesis of HBCN.

### 1.1 Synthesis of 3D Honeycomb Boron Carbon Nitride (HBCN)

Template assisted synthesis protocol has been employed for HBCN synthesis where SiO₂ NPs were used as template. Typically, 1 mole of each of boric acid, glucose and cyanamide solution was infiltrated with colloidal SiO₂ NPs. After the infiltration of the solution, the resulting material was dried at 60° C., followed by pyrolysis at 900° C. in Argon gas for 3 hours. Subsequently, silica@BCN was treated with 10% HF solution for 12 hours to completely dissolve/remove SiO₂ NPs from the product followed by washing with DI water and drying to obtain HBCN.

### 1.2 Material Characterization

Phase purity of prepared sample was studied from Powder XRD analysis which was carried out using Philips X'Pert PRO analytical diffractometer with the nickel-filtered Cu Kα radiation of wavelength 1.5406 Å in 10°-80° 2θ values. Raman analysis was carried out by using LabRam HR800 from JY Horiba micro Raman spectrometer instrument with 632.8 nm diode laser. Morphological study of prepared sample and post cycling electrodes were performed using NOVA NANO FESEM 450 instrument with 18 kV working potential and WD=5.2-5.7 mm. Transmission electron microscopy (TEM) was performed using IFEI, Tecnai F30, FEG microscope operating with 300 kV accelerating potential. X-ray Photoelectron Spectroscopy (XPS) measurements were carried out by using VG Micro Tech ESCA 3000 instrument with monochromatic Al Kα (1486.6 eV) as x-ray source and pressure for the analyser chamber was maintained at 1×10-8 mbar during measurements. The surface area study was performed using Brunauer-Emmett-Teller (BET) adsorption method with the help of Quantachrome BET surface analyser with N₂ adsorption up to 1 bar on the surface of sample.

The honeycomb boron carbon nitride (HBCN) as synthesized has porosity in the range from 300 to 500 nm and is mesoporosity in the range of 2 to 10 nm with plated/deposited ion is used as anode in sodium ion battery.

### Example 2: HBCN Half-Cell Electrochemical Data

Considering the dual doping and tailored structure of HBCN, it was tested as anode for Na-ion battery. HBCN was tested as anode in half-cell in different electrolytes. Rate performance of HBCN is shown in FIG. 2. Capacity obtained at 100 mAg⁻¹ in NaPF₆-diglyme based electrolyte is 290 mAhg⁻¹ and in NaClO₄-EC/DMC electrolyte capacity is 140 mAhg⁻¹. Stability comparison of HBCN in different electrolytes is shown in FIG. 3 which indicates that half-cell capacity is similar in 1M NaPF₆-glyme and 1 M NaPF₆ in 1:1 EC and DEC with 5% FEC electrolytes. But capacity is lower in 1 M NaClO₄ in 1:1 EC and DMC with 5% FEC Electrolyte.

### Example 3: NVPF Half-Cell Electrochemical Data

Half-cell performance of NVPF is shown in FIG. 4 in diglyme electrolyte. Capacity obtained for NVPF at 100 mAhg⁻¹ is 110 mAhg⁻¹.

### Example 4: HBCN∥NVPF Full Cell Electrochemical Data

Based on the half-cell performance of HBCN and NVPF, mass balancing was done and for full cell mass ratio of cathode to anode is 2:1. Before fabricating full cell, anode and cathode electrodes were pre-sodiated for 30 minutes. Four different pre-sodiation conditions studied are:
1. Without pre-sodiation;
2. Cathode pre-sodiated for 30M;
3. Anode pre-sodiated for 30M; and
4. Anode and cathode pre-sodiated for 30M.

CV curves of without pre-sodiated and pre-sodiated cathode and anode are shown in FIG. 5. From, CV curves it can be observed that the reversibility of peak at 4.1 V is increased in the case of pre-sodiated electrodes than full cell without pre-sodiated electrodes.

Furthermore, increased in the capacity retention in the case of pre-sodiated full cell was understood from stability data. Full cell stability data is shown in FIG. 6. In case of full cell fabricated without pre-sodiation of electrodes, the capacity is 16 mAhg⁻¹ at 50 mAg⁻¹. In cathode pre-sodiated full cell, the capacity is 33 mAhg⁻¹ at 50 mAg⁻¹. In anode pre-sodiated full cell, the capacity is 28 mAhg⁻¹ at 50 mAg⁻¹. In full cell wherein cathode and anode both pre-sodiated, capacity is 41 mAhg⁻¹ at 50 mAg⁻¹.

At 1C, capacities are 12, 25, 22 and 31 mAhg⁻¹ in case of without pre-sodiation, cathode pre-sodiation, anode pre-sodiation and both electrodes pre-sodiation case.

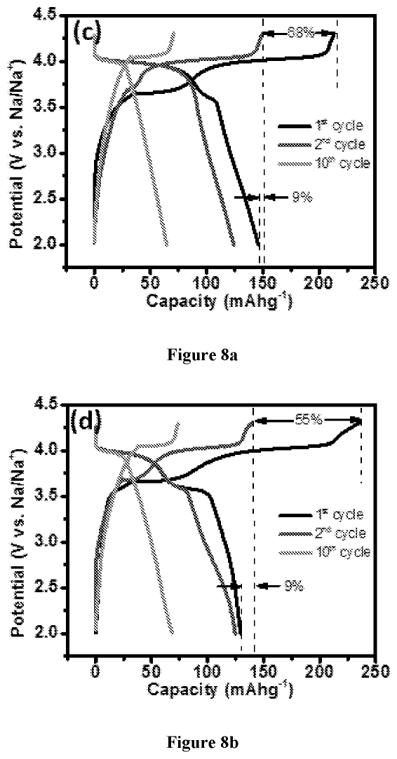

GCD curves of different full cells are shown in FIG. 7. In full cell without pre-sodiation, due to irreversible loss of Na-ion during SEI formation capacity retention in 2nd charge cycle is 18%. When cathode was pre-sodiated for 30M, CEI will be formed before full cell fabrication so irreversible loss of Na ions will be decreased and capacity retention was increased to 24%. In anode pre-sodiation, capacity retention was increased to 68% due to SEI formation on anode so no irreversible trapping of Na-ions. When anode and cathode both were pre-sodiated, capacity retention is 55% and stable capacity is highest among all cases as shown in FIG. 8.

### ADVANTAGES OF THE INVENTION

Boosting the electrochemical performance of half cell and full cell sodium ion-battery comprising 3D honeycomb boron carbon nitride (HBCN) as an anode.

What is claimed is:

1-10. (canceled)

11: A sodium ion battery, comprising:
a) an anode,
wherein the anode is honeycomb boron carbon nitride nanomaterial, and
wherein the honeycomb boron carbon nitride nanomaterial is mesoporous and plated or deposited with sodium;
b) a cathode,
wherein the cathode is Na₃V₂(PO₄)₂F₃ (NVPF);
c) one or more electrolytes;
d) optionally, an additive; and
e) separator.

12: The battery as claimed in claim 11, wherein the honeycomb boron carbon nitride nanomaterial has a porosity in a range from 300 to 500 nm and mesoporosity in a range of 2 to 10 nm, and
wherein the honeycomb boron carbon nitride nanomaterial has a surface area ranging between 400-800 m².

13: The battery as claimed in claim 11, wherein the one or more electrolytes is sodium hexafluorophosphate salt in diglyme (NaPF₆-diglyme), sodium hexafluorophosphate salt in ethylene carbonate or propylene carbonate and fluoroethylene carbonate (NaPF₆-EC/PC+FEC), sodium hexafluorophosphate salt in propylene carbonate (NaPF₆-PC), sodium hexafluorophosphate salt in ethylene carbonate or diethyl carbonate and fluoroethylene carbonate (NaPF₆-EC/DEC+FEC), sodium perchlorate-ethylene carbonate or dimethyl carbonate and fluoroethylene carbonate (NaClO₄-EC/DMC+FEC), or a mixture thereof.

14: The battery as claimed in claim 11, wherein the separator is Whatman glass fiber or celgard.

15: The battery as claimed in claim 11, wherein the sodium-ion battery is a half-cell battery or a full-cell battery.

16: The battery as claimed in claim 11, wherein mass loading of anode to cathode in the battery is from 1:1 to 1:3, and
wherein the cathode and the anode are pre-sodiated by shorting for 10-90 minutes.

17: The battery as claimed in claim 11, wherein the sodium-ion battery is a half-cell battery or a full-cell battery,
wherein mass loading of anode to cathode in the battery is from 1:1 to 1:3,
wherein the cathode and the anode are pre-sodiated by shorting for 10-90 minutes,
wherein capacity of the anode in the half-cell battery is in a range of 140 to 290 mAhg⁻¹; and
wherein capacity for the cathode in the half-cell battery is in a range of 100-110 mAhg⁻¹, obtained at 100 mAg⁻¹ current density.

18: The battery as claimed in claim 11, wherein the sodium-ion battery is a half-cell battery or a full-cell battery,
wherein mass loading of anode to cathode in the battery is from 1:1 to 1:3;
wherein the cathode and the anode are pre-sodiated by shorting for 10-90 minutes,
wherein capacity of the pre-sodiated cathode in the full-cell battery is 33 mAhg⁻¹ at 50 mAg⁻¹,
wherein capacity of the pre-sodiated anode in the full-cell battery is 28 mAhg⁻¹ at 50 mAg⁻¹, and
wherein capacity of the pre-sodiated cathode and anode in the full-cell battery is 41 mAhg⁻¹ at 50 mAg⁻¹ current density.

19: A process for preparation of the anode as claimed in claim 11, comprising:
i. creating a slurry by mixing the honeycomb boron carbon nitride nanomaterial as an active material, a conducting additive, and a binder in a ratio of 70:10:10 or 80:10:10, in a solvent;
ii. casting the slurry on a current collector or a conducting metal, and
iii. drying the slurry that has been cast on a current collector or a conducting metal at 70-120° C. for 12-24 hours in a vacuum oven.

20: The process as claimed in claim 19, wherein the conducting additive is super P carbon black, C65, or CNT; the binder is Polyvinylidene fluoride, carboxymethylcellulose, or polyacrylic acid; and the solvent is N-Methyl-2-pyrrolidone or water.
